(19) United States
(12) Patent Application Publication
(10) Pub. No.: US 2001/0046034 A1
(43) Pub. Date: Nov. 29, 2001

(54) Machine for creating handheld illumination and projectable multimedia presentations

(76) Inventors: Robert J. Gold, Madison, WI (US); Keith A. Kritselis, Austin, TX (US)

Correspondence Address: Robert J. Gold, 3749 Maple Grove Drive, Madison, WI, 53719, US

(21) Appl. No.: 09/788,788

(22) Filed: Feb. 20, 2001

Related U.S. Application Data
(60) Provisional application No. 60/183,420, filed on Feb. 18, 2000.

(51) Int. Cl. G03B 21/30

(52) U.S. Cl. 353/72

(57) ABSTRACT

A machine for creating handheld illumination and multimedia presentations with an integral, controllable and projectable, LCD screen utilizing the illumination source to backlight or project the miniature LCD screen. The unit can provide the user with a combination of a flashlight and/or a LCD data information and presentation system. The unit has a detachable translucent screen on which a projected image can be viewed so that the image is enlarged to increase the actual viewing area while still remaining portable and handheld. The translucent nature of the screen allows the projected image to be seen through the screen and the device has the ability to invert, reverse or otherwise manipulate the image for proper viewing regardless of the screen type or orientation to the image projected. The unit has the ability to control the output to the screen data so that static, animated and video images can be displayed or projected by the unit. The unit has the ability to accept various types of data entry in connection with the output seen on the screen. The unit can use onboard or connectable input controls to play games, manipulate on-screen commands and generally interface with the data producing the images generated by the device. The projection hardware has the ability to focus the light from the handheld illumination source in a manner consistent with rendering an accurate and viewable image on any surface used as a screen by the device.

### CROSS REFERENCE TO RELATED APPLICATIONS

This Patent is entitled to the benefit of Provisional Patent Application Ser. No. 60/183420 Filed Feb. 18, 2000

### BACKGROUND

1. Field of Invention

This invention relates to a combination handheld illumination and presentation device, specifically to a portable handheld device that allows both the use of the light source as an illumination device and as a presentation system that enables the projection of static, animated and video images on, and onto, a variety of integral and non-integral surfaces so that they can be shared with other individuals without the need of an external computer or video monitor.

2. Background

The use and functionality of handheld illumination sources such as flashlights are well known. It is a device that creates a light beam can be used in many emergency and non-emergency situations. It has become a ubiquitous part of family life to have a flashlight in the home, car and other places.

Handheld electronic device that use small screen LCD display technology such as Personal Digital Assistants (PDA's), games and calculators are also a ubiquitous part of the entertainment, business and educational tools available. These devices have limited viewing areas due to the small size of their integral LCD screens. Current games, PDA's and other handheld business and entertainment devices do not have the ability to share their data with other devices which allow the user to see the data on larger screen formats.

Presentation tools like multimedia projectors are also well-known business tools that can take images from laptop computers or their own integral data storage system and via an integral LCD screen or micro mirror system within the device project the image onto a distant wall or screen for business, entertainment or education purposes.

All three concepts have always been separate due to their disparate nature. The present invention, creates a hybrid product that has new and unique capabilities that address all the fields now addressed by the three separate devices, but also creates a new and valuable use methodology that allows the new device to function in many ways that no other single device has ever offered. Additionally, the invention can alter the way other products like PDA'S, cell/digital telephones, GPS units and other small LCD screen devices can be viewed by their users. One of the greatest limiting factors of the portable technology revolution has been the screen size. Utilizing a projection-based system these personal electronics could offer greater service to their customers.

The current technology that is available does not allows for multimedia presentations to be given anywhere for any purpose. The present invention's technology provides for the presentation of many types of data in many types of situations including on-the-go sales and marketing demos, emergency use of the projection to relay vital information to distant viewers, educational use of the presentation to teach both in the class room environment and in the field, large screen gaming, and the combination of various add-on products with the invention that expands the capabilities of the add-on devices to include a projection system for their data.

Background—Market

The market for flashlights is well known and growing each year. The major flashlight manufacturers have saturated the marketplace with almost every conceivable type and style of light source from mini-lights to major lanterns. There have been no innovations in the functionality of flashlights that allow the light to provide any value other than as an illumination system.

The handheld game and business electronics market is rapidly expanding. The proliferation of handheld games and PDA's has created a much lower cost in the manufacture of their components, yet their functionality is still limited by the small size of the screen within these devices. No PDA or other personal electronics device offers any way to expand the viewing area or allow the device to project the data that is viewed on the integral screen of the device.

The presentation device market is also blooming as businessmen on the go are required to make greater numbers of in-person presentations about products and businesses that need multimedia explanations to clearly convey their message. Currently these presentation devices are the size of laptop computers or larger and require an electrical connection to a wall outlet. This limits their application to static environments with power available where the device can be set up for viewing. These devices only have the ability to present their content on large and semi-distant screens. No current presentation system has an integral or attachable screen whiles still possessing the ability to project the data content to a large format.

The market exists for a device that has the capabilities of all three of these devices plus the combination of attributes that allow for unique new functionality. The combination of a handheld illumination system that can utilize its light source to backlight an integral LCD screen or project the information onto an attached or distant screen surface allows presentations to be made almost anywhere that two or more people can gather. Additionally, the ability to combine input sources from PDA's, games or other small screen devices and project them into a larger format creates many opportunities to work and play more easily in many situations and locations.

Background—Description of Prior Art

Several patents address the individual components of, and modifications to, elements of the three inventions, flashlights, handheld electronics and projection presentation systems, described above. But no other patent addresses the combined elements that give the current invention its unique and novel abilities and characteristics.

### SUMMARY

In accordance with the present invention a handheld device comprises a light source capable of creating a light beam that can be used for area illumination alone, or as the illumination means for backlighting an image created on an integral controllable LCD screen, or as an illumination means for projecting an image from said LCD screen onto an attachable or distant screen surface. The present invention can also be created utilizing micro-mirror technology (by Texas Instruments) that can create images via light refraction and reflection. If the invention utilizes micro-mirror technology then the illumination means would create the image with the micro-mirror technology and project it onto an integral translucent mini-screen for handheld viewing or out of the invention for projection on an attached or distant screen surface.

### Objects and Advantages

Accordingly, besides the objects and advantages of the invention described in the summary above, the following objects and advantages of the present invention are:

(a) To provide the user with a combination of a handheld flashlight and data information system.

(b) To provide the ability of the integral data information system to control the output to the screen (integral, attached or distant) so that static images, animated images and video images are capable of display by the unit.

(c) To provide the ability of the data information system to accept various types of data entry in connection with the output seen on the screen. The data can be accepted via direct cable or hardware connection link, via infrared transmission and by any normal methodology used to transfer data between electronic devices.

(d) To provide the ability to derive the data (for controlling the screen output) from onboard memory, removable modular memory, downloaded instructions from another computer source or from the Internet, or to be input manually by the user via onboard or connectable input controls.

(e) To provide the ability to use onboard or connectable input controls to play games, manipulate on-screen commands and generally interface with the data producing the images generated by the invention.

(f) To provide the ability of the flashlight to work independently from the integral screen or projection system.

(g) To provide the ability to use the flashlight as a backlight for the basic integral screen (i.e. LED) in it's most miniature format.

(h) To provide the ability to use the flashlight as the illumination source for projecting the screen content onto a screen different than the actual surface of the integral screen.

(i) To provide the ability to have an attachable fold-out, or other methodology, screen system which will allow the projection of the integral screen content onto a portable close range screen that amplifies the view of the basic miniature integral screen—in such a way as to increase the actual viewing area while still remaining portable and hand-held.

(j) To provide the ability of the invention to have a screen attachment system for a standoff screen made of translucent material for the purpose of projecting the image in such a fashion that it could be viewed from either side of the translucent screen material.

(k) To provide the ability of the invention to project the image onto a distant screen surface like a wall.

(l) To provide the ability of the projection hardware within the invention to focus the light from the illumination means in a manner consistent with rendering an accurate and viewable image on any of the screen types and surfaces mentioned above.

(m) To provide the ability of the invention to operate on internal battery power, or to be plugged into a standard power outlet, or to be powered from a variety of optional sources like a car lighter outlet.

(n) To provide the ability of the control system of the invention to reverse the image both in a mirror fashion and horizontally and vertically, as desired, so as to allow the transmission of the proper image format via reflection, translucent screen material or direct image projection and viewing.

(o) To provide the ability of the system to allow the user to control the light function for the best backlighting under any light condition from bright daylight to total darkness.

(p) To provide the ability of the projection system's adjustment system to compensate for the “keystone effect” caused by the angular displacement of the beam on the screen.

(q) To provide the ability to change light portal openings for proper display of the light beam during various modes of operation.

Further object and advantages of the invention will become apparent from a consideration of the drawings and ensuing description.

### DRAWING FIGURES

FIG. 1. Shows a cross-sectional side view of invention in backlight mode of integral LCD.

FIG. 2 shows a cross-sectional side view of invention with LCD in Backlight mode an d light hood motion indicated by dotted lines.

FIG. 3. Shows a cross-sectional side view of invention with light hood motion in raised position and LCD motion as indicated by dotted lines.

FIG. 4. Shows cross-sectional side view of invention in projection mode (with callouts)

FIG. 5. Shows cross-sectional side view of invention in projection mode (with rear lens callout).

FIG. 6. Shows cross-sectional side view of invention in LCD backlight mode with callouts

FIG. 7. Shows cross-sectional side view of invention in direct illumination mode.

FIG. 8. Shows a cross-sectional side view of invention in LCD Backlight mode

FIG. 9 shows a cross-sectional side view of invention in Flashlight mode

FIG. 10 shows a cross-sectional side view of invention in Projection mode

FIG. 11. Shows a side plan view of the invention with attached screen

FIG. 11a. Shows a side plan view of the invention with attached screen

FIG. 12. Shows a perspective view of the invention in use as a projection system with an attached screen.

FIG. 13. Shows a perspective view of the invention in use as a projection system with projection on a wall surface.

FIG. 14. Shows a perspective view of the invention in use as a projection system with projection on a close un-attached surface.

FIG. 15. Shows a perspective view of an individual using the invention in an emergency use capacity.

FIG. 16. Shows a perspective view of an individual using the invention in a promotional capacity.

FIG. 17. Shows a perspective view of an individual using the invention in an instructional capacity.

FIG. 18. Shows a perspective view of an individual using the invention in a traffic control capacity.

FIG. 19. Shows a set of side, top and front orthographic plan views of the exterior of the invention while the light hood is in motion.

FIG. 20. Shows a set of side, top and front orthographic plan views of the exterior of the invention in flashlight mode. This view also shows details of the six basic electronic controls of the invention.

FIG. 21a-21c show three close up partial views of the invention's lever controls that activate motion and determine placement of the light hood and the LCD screen.

FIG. 22. Shows a cutaway 3D side view of the major components of the invention in the LCD backlight mode.

FIG. 23. Shows a cutaway 3D side view of the major components of the invention in the flashlight mode.

FIG. 24. Shows a cutaway 3D side view of the major components of the invention in the projection mode.

FIGS. 25a. and 25b show a cross-sectional side view of the invention with the tilt adjustment for projection system in two positions.

FIGS. 26a. and 26b shows a cross-sectional view of invention with the focus adjustment for projection system in two positions.

FIG. 27 shows a cross-sectional side view of invention with an un-attached screen system

FIG. 28 shows a 3D side plan view of invention with an un-attached screen system and an ached external adaptor and attached external device (PDA shown).

FIG. 29 shows a 3D side plan view of the invention with an attached screen system

FIG. 30 shows a 3D top plan view of the invention with an attached screen system.

FIG. 31 shows a 3D front perspective view of the invention with an attached screen system

FIG. 32 shows a 3D rear-side perspective view of the invention with an attached screen system

FIG. 33 shows a 3D side perspective view of the invention with an attached screen system an attached external adaptor and an attached external device (PDA shown).

FIG. 34 shows a 3D side-rear perspective exploded assembly view of the invention with un-attached screen system and an un-attached PDA Adaptor and an un-attached external device (PDA shown).

FIG. 35 shows the internal components of Front assembly 14 with details of the focusing mechanism for the projection and illumination functions.

FIG. 36 shows a schematic block diagram of the flow of commands and information within the invention.

### REFERENCE NUMERALS IN DRAWINGS

| | |
|---|---|
| 1 | Exterior body of invention |
| 2 | End cap/battery retention cap |
| 3 | Batteries |
| 4 | Reflector |
| 5 | Light bulb |
| 6 | Rear convex lens |
| 7 | Screen attachment slots |
| 8 | Motion cavity |
| 9 | Light hood |
| 10 | Front lens adjustment rail |
| 11 | Front lens carrier tube |
| 12 | Front lens |
| 13 | Exterior light aperture tube |
| 13a | threads (of light aperture tube) |
| 14 | Front assembly |
| 15 | LCD screen in carrier |
| 16 | Hinge of light hood |
| 16a | Light Hood hinge in down |
| | position (backlight mode) |
| 16b | Light Hood hinge in up position |
| | (flashlight or projection mode) |
| 17 | Hinge of LCD carrier |
| 17a | LCD Carrier hinge in up position |
| | (backlight or flashlight mode) |
| 17b | LCD Carrier hinge in down |
| | position (projection mode) |
| 18 | External systems adaptor |
| 19 | Control assembly |
| 19a | Selector button |
| 19b | left half Circular button |
| 19c | Central Mouse multidirectional control |
| 19d | right half Circular button |
| 19e | Off button |
| 19f | On button |
| 20 | Internal circuitry board |
| 21 | Insertable screen posts |
| 22 | Adjustable screen hinge |
| 23 | Translucent screen |
| 24 | Screen post holes in body |
| 25 | Adjustment pins |
| 26 | Electronics assembly |
| 27 | Cable 18 to 19 |
| 27a | Cable 19 to 5 |
| 28 | Cable 19 to 20 |
| 29 | Cable 18 to 17 |
| 30 | LCD adjustment handle |
| 31 | Light hood adjustment handle |
| 32 | Add-on screen assembly |
| 33 | Projected image |
| 34 | Illumination beam |
| 35 | Front Lens threads |
| 36 | PDA Adaptor |
| 37 | PDA Unit |
| 38 | Lens Holder |
| 39 | Back Light Beam |
| 40 | Reversed Image |
| 41 | Lens Focus Rails |
| 42 | Groove (on front of Front Carrier |
| | tube) |
| 43 | Retainer Protrusions (on rear of |
| | Light Aperture Tube) |

### PREFERRED EMBODIMENT OF INVENTION

### Description of the Elements of the Invention

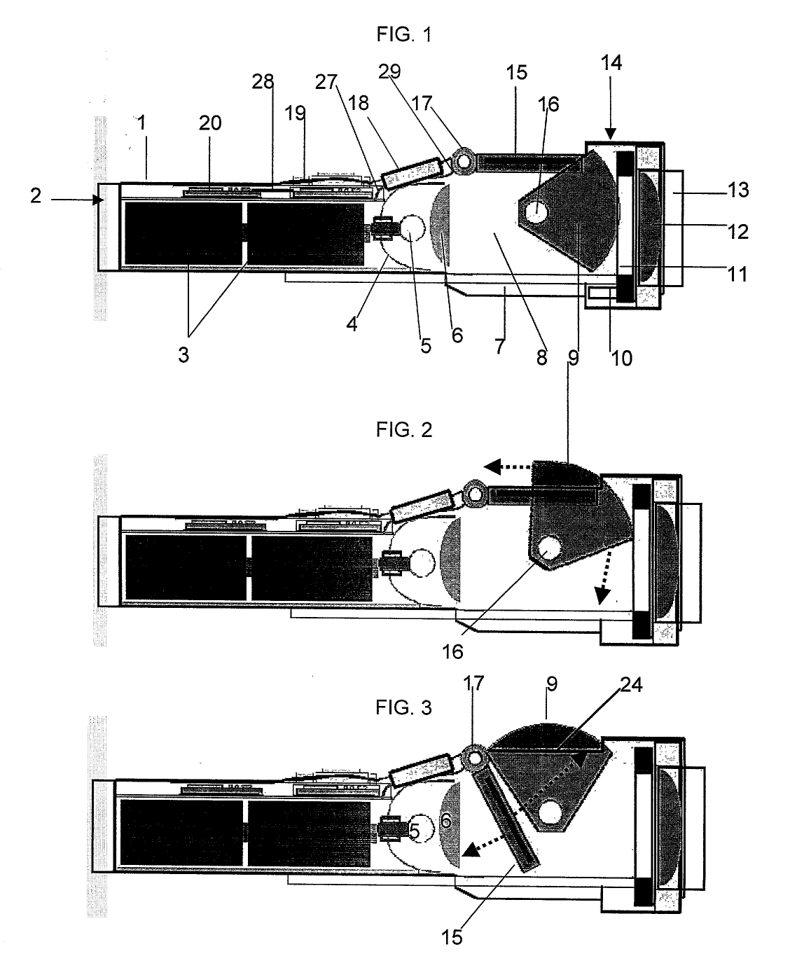

The preferred embodiment of the present invention is shown in FIG. 1, FIG. 2 and FIG. 3, and has an exterior case 1 which generally has the shape of a standard handheld tubular flashlight. The rear of the light having a cap 2 of the same general diameter with an integral attachment system (i.e. threads, bayonet, etc.) that match to a mating integral attachment system (i.e. threads, bayonet, etc.) on the body 1 thus creating a seal at the rear of the tubular hand held section. Within the case 1 is space for one or more batteries 3 that are disposed within the case so that their rear-most end touches a connection point to the end cap 2 and forward-most front end touches a connection point to the back of light bulb 5. Light bulb 5 is held in place within the body of reflector 4 that sits linearly in front of the battery area within walls of the tubular cavity of body 1. Dome shaped rear lens 6 is positioned so that its convex side is held in front of reflector 4 and bulb 5 so that any light emitted by bulb 5 will be channeled through rounded side of rear lens 6. The channeled light exits the flat side of rear lens 6 and enters the motion cavity 8 that occupies the area directly in front of the rear lens 6.

Motion cavity 8 has space within the body 1 passage of light from the rear lens 6 as well as for the movement of light hood 9 to freely pivot on its hinge 16 and for movement of LCD screen 15 to freely pivot on its hinge 17. The LCD hinge 17 with the LCD screen in its carrier 15 is attached perpendicular to the length of body 1 of the invention at the top of the motion cavity 8.

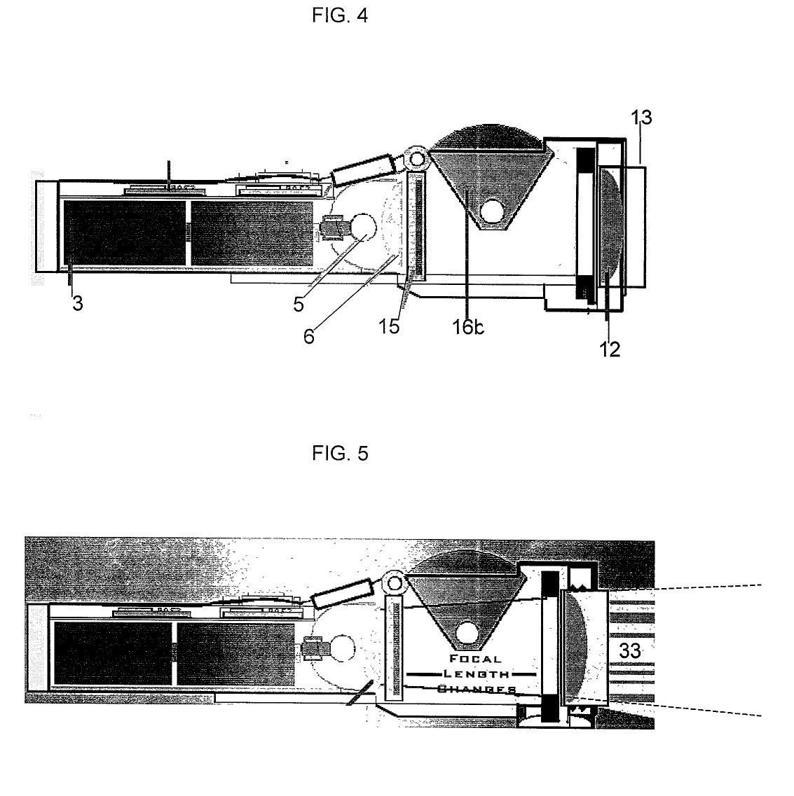

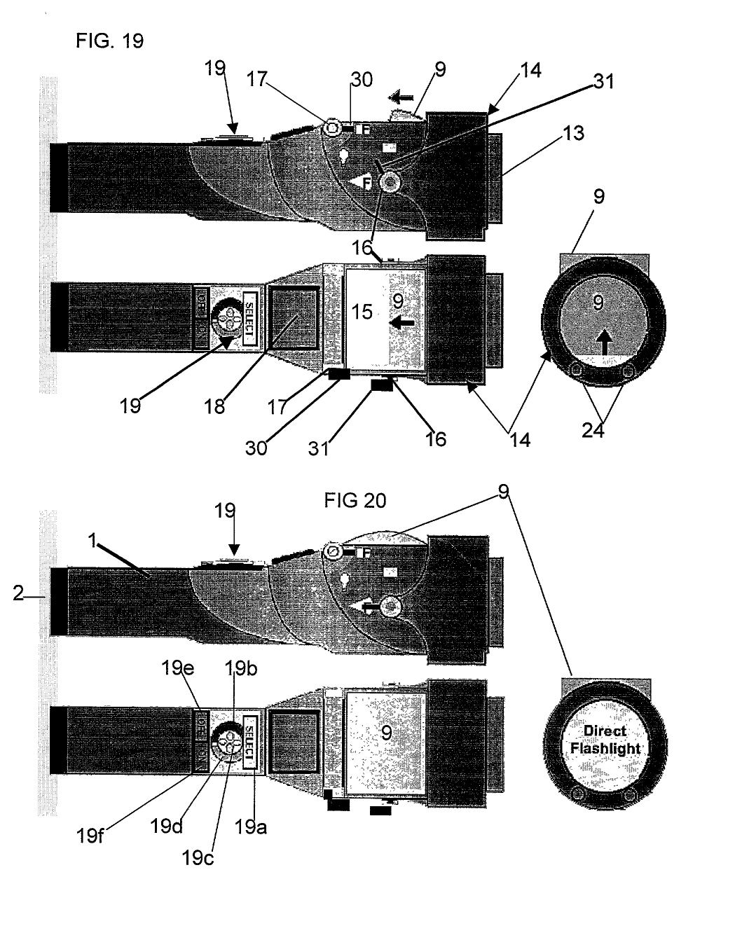

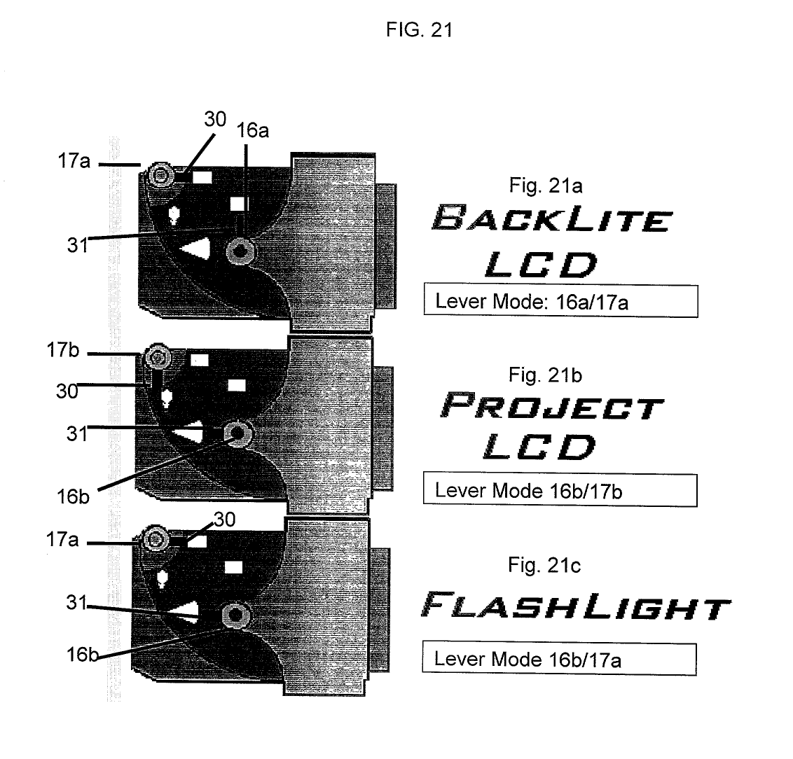

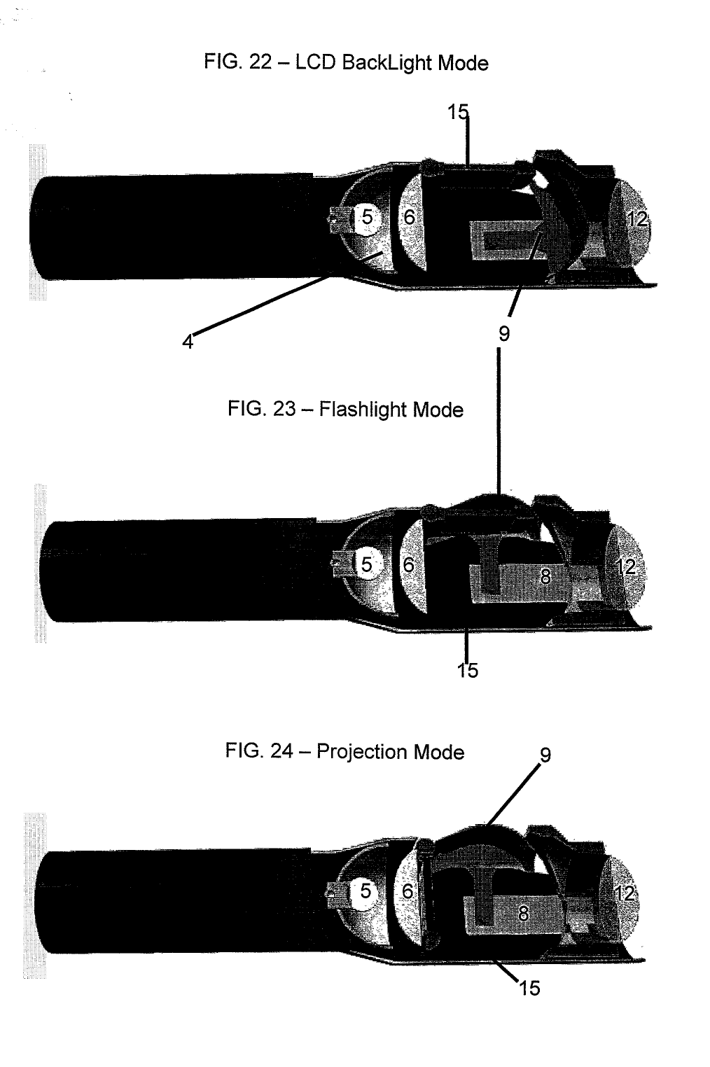

As shown in FIG. 4 and FIG. 5, the LCD hinge 17 placement is in a position that allows the LCD screen in its carrier 15 to pivot on the hinge 17 so that LCD Screen in its carrier 15 can be pivoted (pivot motion shown by dotted lines in FIG. 3) to and from a position where it can either sit directly in front of the light output from the flat side of rear lens 6 when light 5 is activated, or where the LCD screen in its carrier 15 sits in a position parallel with the length of the body 1 (as shown in FIG. 1 and FIG. 2) and covers the body opening 24 in the top of motion cavity 8. The body opening 24 is the same size as the LCD screen's 15 viewing area. The side flanges of opening 24 are the retaining wall that stops the free swing of the LCD in its carrier 15 from swinging past the opening in the body 1 of the invention. Integral molded or attached design elements in the body 1 keep the LCD screen in its carrier 15 securely in either raised position (covering the opening 24) or lowered position (sitting in front of light 5 and rear lens 6). The rotation of LCD screen in its carrier 15 is accomplished manually using LCD adjustment handle 30 (shown in FIGS. 19 and 21a-21c) that is found on both ends of LCD hinge 17. Both ends of LCD hinge 17 have the LCD adjustment handle 30 that is positioned perpendicular to the shaft of the hinge 17. As shown in FIG. 2,the light hood 9 pivots on hinge 16 that rotates to two positions within the motion cavity 8 of body 1. The rotation of light hood 9 is accomplished manually using light hood adjustment handle 31(shown in FIGS. 19 and 21a-21c) that is found on both ends of hinge 16. Both ends of hinge 16 have the light hood adjustment handle 31 that is positioned perpendicular to the shaft of the hinge 16. The Light hood 9 has a shape generally similar to a section of a hollow drum that has been cut from its circumference to its center point so that a hollow “U” or “bucket” shape is created. The parallel sides of the “U” shape have a pivot hole 16 that acts as a hinge point on which light hood 9 can rotate.

As shown in FIG. 1, in its down position the main mass of light hood 9 is directly in line with the light of bulb 5 and rear lens 6 on the opposite side of the motion cavity 8. In its rotation from the down position in FIG. 1 to its position as shown in FIG. 3, where it is shown shrouding the opening 24 in the body 1 of the invention, the light hood 9 moves on the pivot action of hinge 16. This motion can be seen in the dotted motion lines shown in FIG. 2. In its position of shrouding the opening 24, the bulk of the pie shaped drum section of light hood 9 moves into an area over opening 24, where part of the light hood 9 is outside the body 1 of the invention (as shown in FIG.'s. 3, 4, 5, 7, 9 and 10). In this position the light hood 9 can cover the empty opening 24 (as shown in FIGS. 3 and FIG. 10), or the LCD screen in its carrier 15 when both are rotated up into the opening 24 position (as shown in FIG. 7 and FIG. 9).

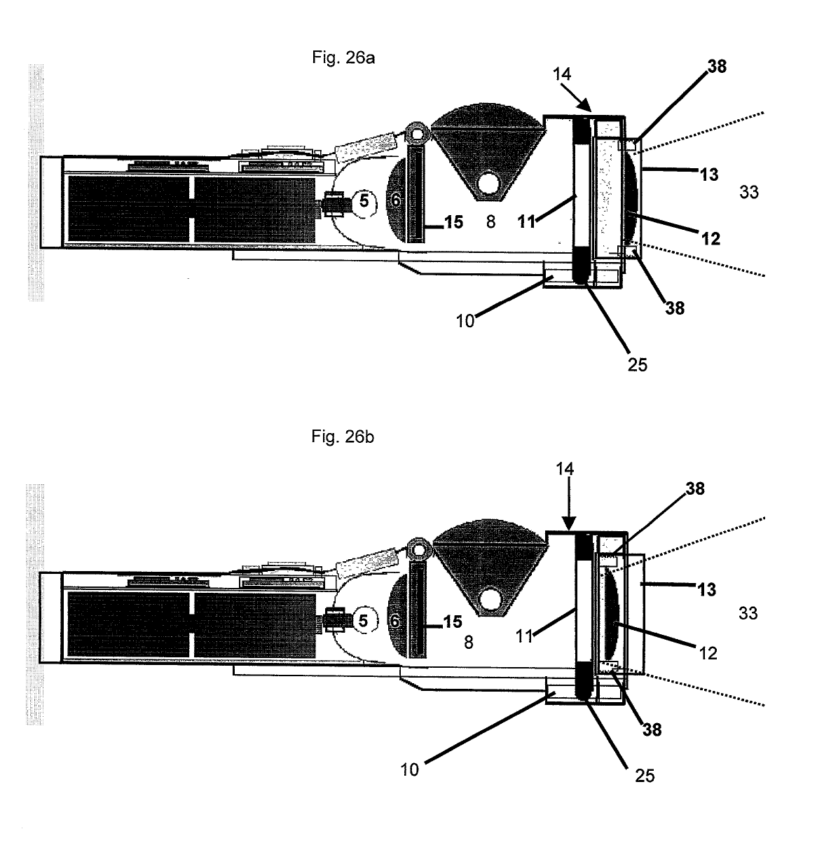

As shown in FIG. 1, front assembly 14 is directly centered in the front section of the body 1 and in line with rear lens 6 but on the opposite side of light hood 9. Front assembly 14 is composed of the front lens adjustment rail 10 that holds the front carrier tube 11 on which the front lens 12 is mounted on a screw thread 35 (as shown in FIGS. 26a and 26b) inside the protective exterior light aperture tube 13.

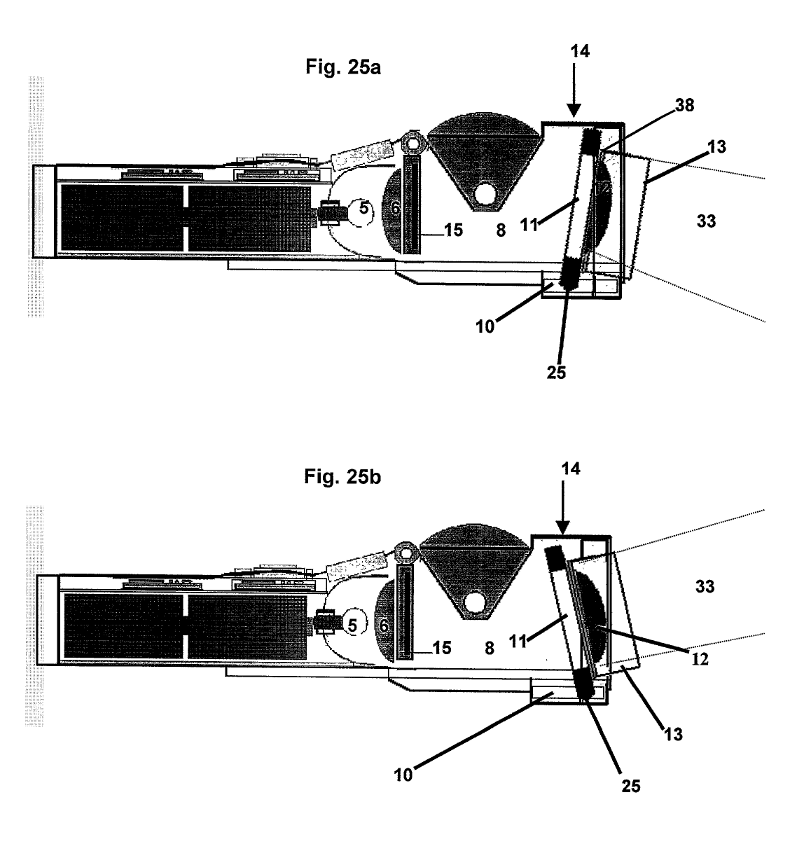

As shown in FIG. 25a and FIG. 25b the front carrier tube 11 has two location adjustment pins 25 that ride snugly but are movable both linearly and rotationally within the front lens adjustment rail 10 that is found on the lower portion of both sides of the front assembly 14. The location pins 25 allow the front carrier tube 11 with the front lens 12 inside of attached exterior light aperture tube 13 to be manually rotated on the axis of the location adjustment pins 25 to adjust the angle of the front carrier tube 11 in relation to the body 1.

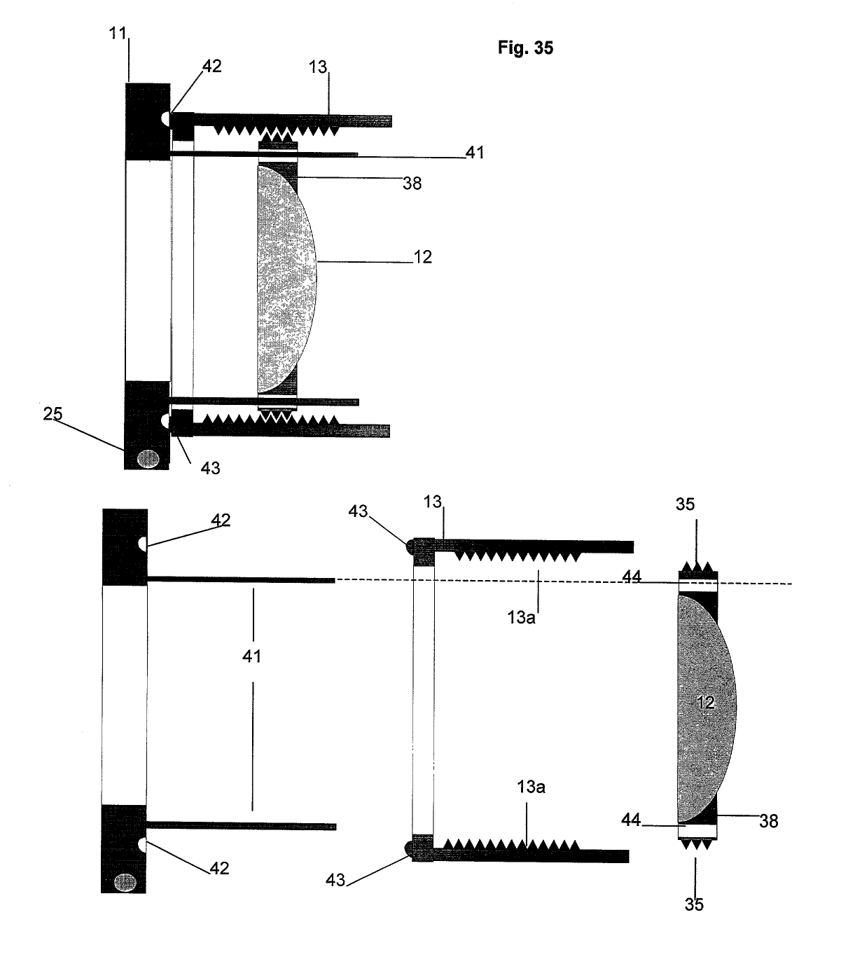

As shown in FIG. 35 (with motion shown in FIG. 26a and FIG. 26b) exterior light aperture tube 13 is mounted via a mated molded configuration to the front carrier tube 11. These mating parts are via a groove 42 in the forward face of front carrier tube 11 that accepts retainer protrusions 43 in the rear surface of the exterior light aperture tube 13. Front lens 12 rides in lens holder 38 that has threads on its exterior circumference. Front carrier tube 11 has one or more lens focus rails 41 that protrude down the interior length of the interior surface of the exterior light aperture tube 13. The front lens 12 in lens holder 38 has holes that allow lens focus rails 41 to pass through the lens holder 38. The front lens 12 in lens holder 38 has the mating threads to the threads 35 that are integral to the interior circumference of exterior light aperture tube 13. The front lens 12 is mounted on lens holder 38 inside the protective exterior light aperture tube 13 so that the distance between the rear lens 6 and the front lens 12 can be incrementally adjusted by the manual adjustment of the linear motion of the front lens 12 on threads 35 and 38.

As shown in FIG. 1 and FIG. 34 external systems adaptor 18 sits on the top exterior of body 1 behind the LCD hinge 17. External systems adaptor 18 is connected to LCD hinge 17 and LCD screen in its carrier 15 by cable 29. External systems adaptor 18 is also connected to control assembly 19 by cable 27. The control assembly 19 is also connected to the internal circuitry board 20 by cable 28. All six control buttons 19a, 19b, 19c, 19d, 19e and 19f are also connected into both cables 28 and 27 at the control assembly 19

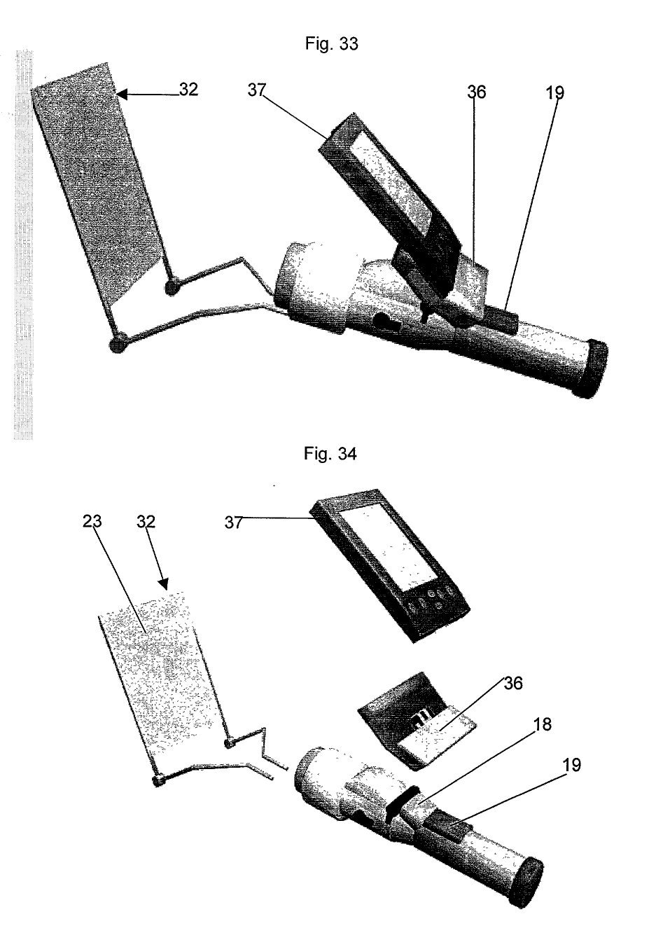

As shown in FIG. 33 and FIG. 34 the external systems adaptor 18 can allow an adaptor fittings 36 to join with the invention and interface with the controls 19. The external systems adaptor 18 port is connected to controls 19 via cable 27. The external systems adaptor 18 has a connection port that is capable of accepting an external device adaptor 36 that allow external devices 37 (i.e. PDA's or other computer systems) to be attached to adaptor 18. Controls 19 are located within the interior space of body 1 and on top of the body 1 via ports in the body 1 specifically shaped to allow protrusion of the control surfaces 19 through the body 1. Controls 19 and internal circuitry board 20 are attached by cable 28 (as shown in FIG. 1).

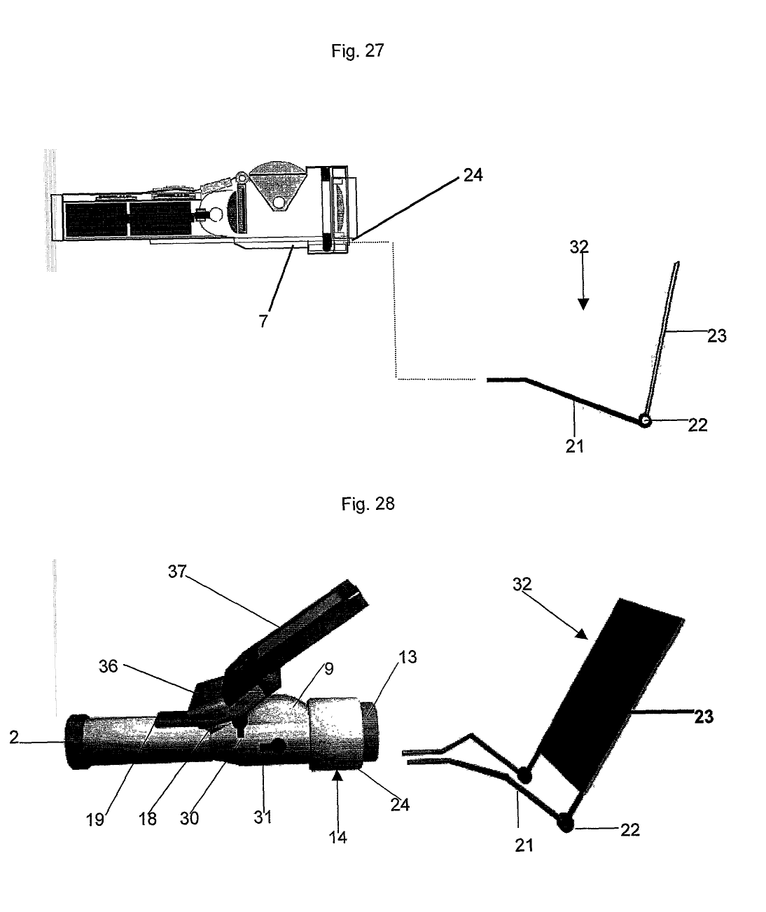

As shown in FIG. 27 and 28 a screen assembly 32 is positioned to be attached to the invention. The screen assembly 32 is composed of a pair of insertable screen posts 21 that are connected to an adjustable screen hinge 22 that can re-position the translucent screen 23.

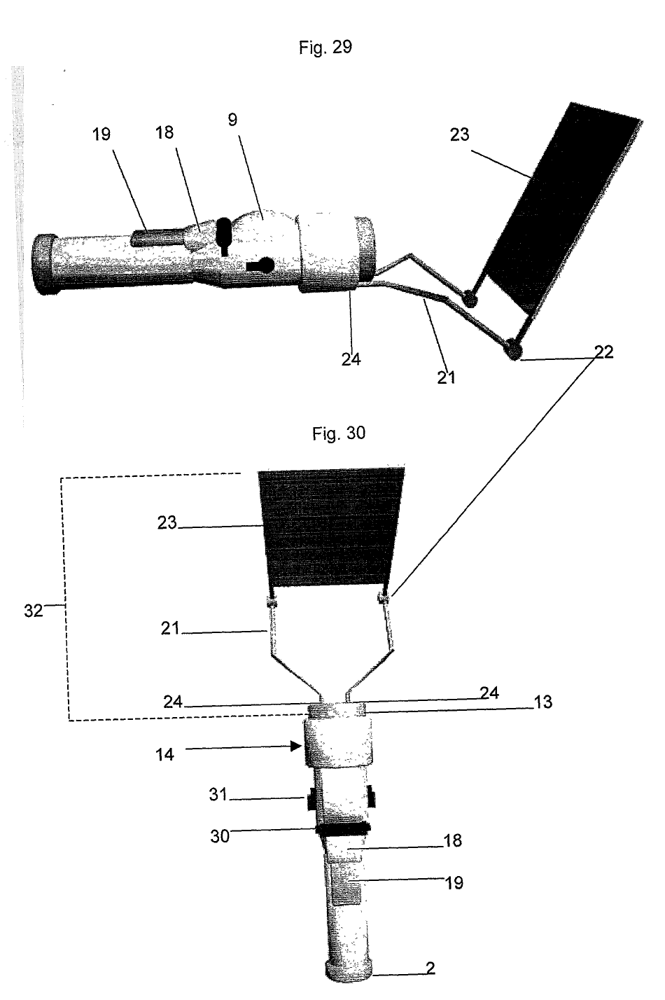

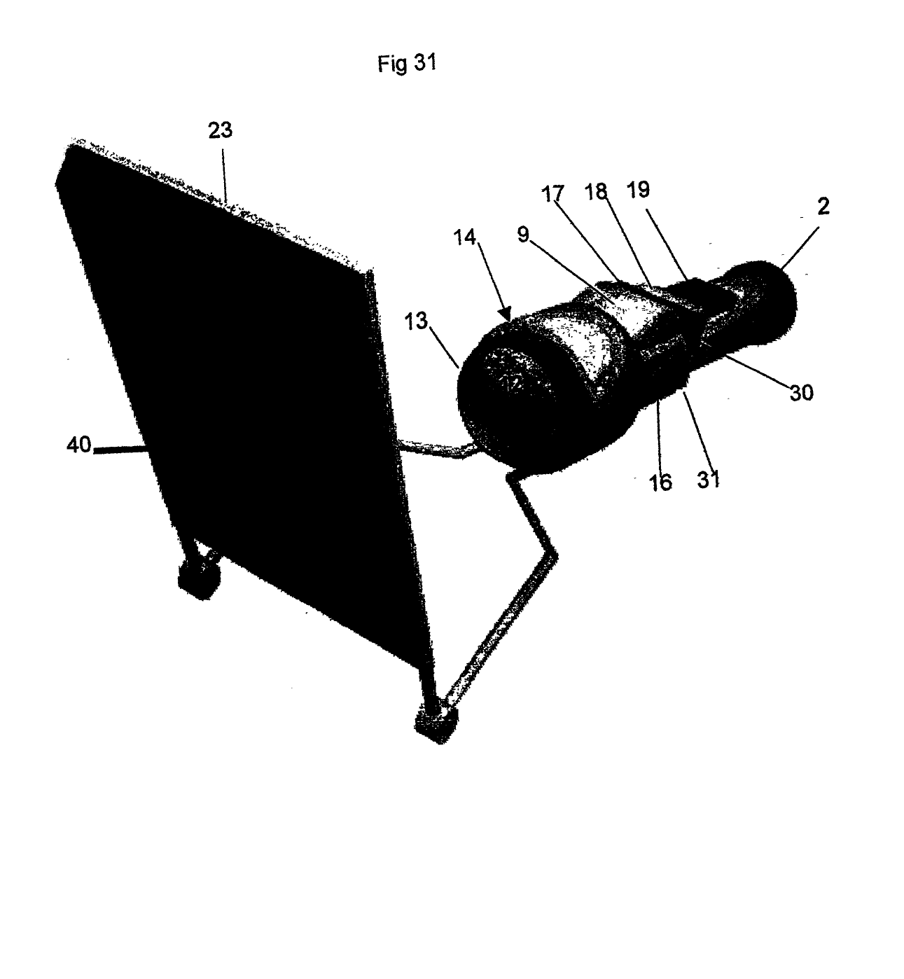

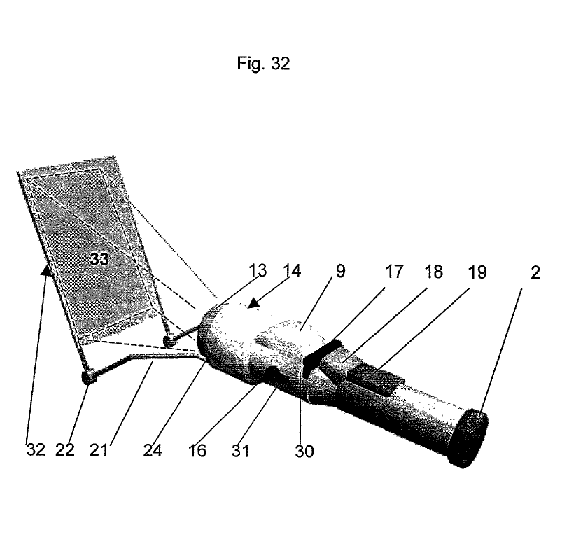

FIG. 29 (side exterior view), FIG. 30 (top exterior view), FIG. 31 (front perspective view) and FIG. 32 (rear perspective view) all show different views of the invention with an attached screen assembly 32.

The following listed Figures show a projected image 33 coming from the invention:

FIG. 5 shows a side cutaway view of the invention in the LCD Projection mode;

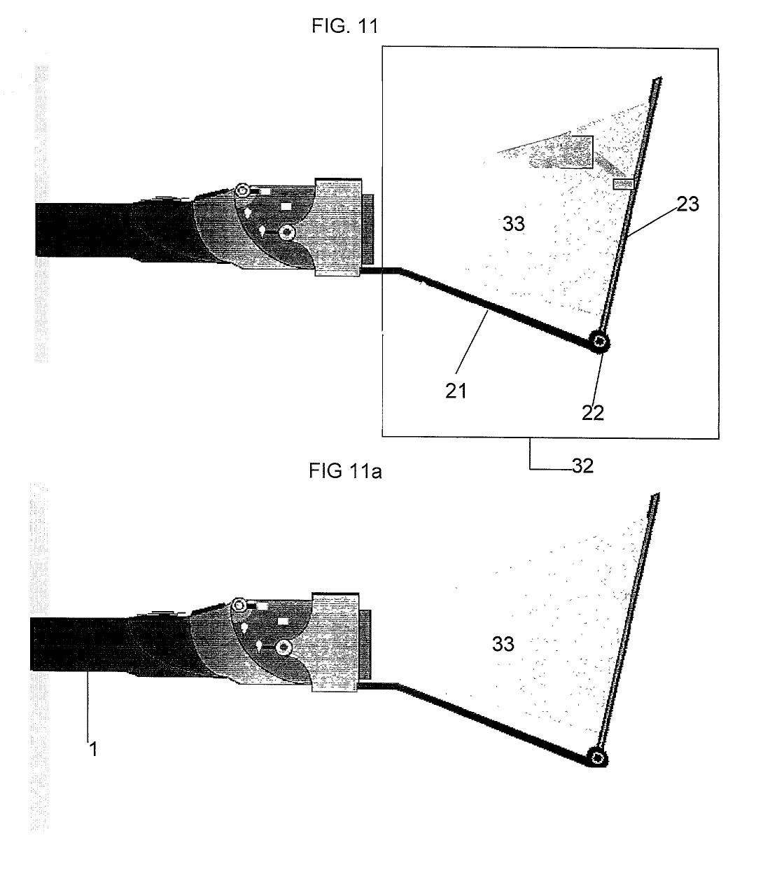

FIG. 11 and FIG. 11a show a side plan view of the invention projecting an image 33 onto screen 23 of attached screen assembly 32.

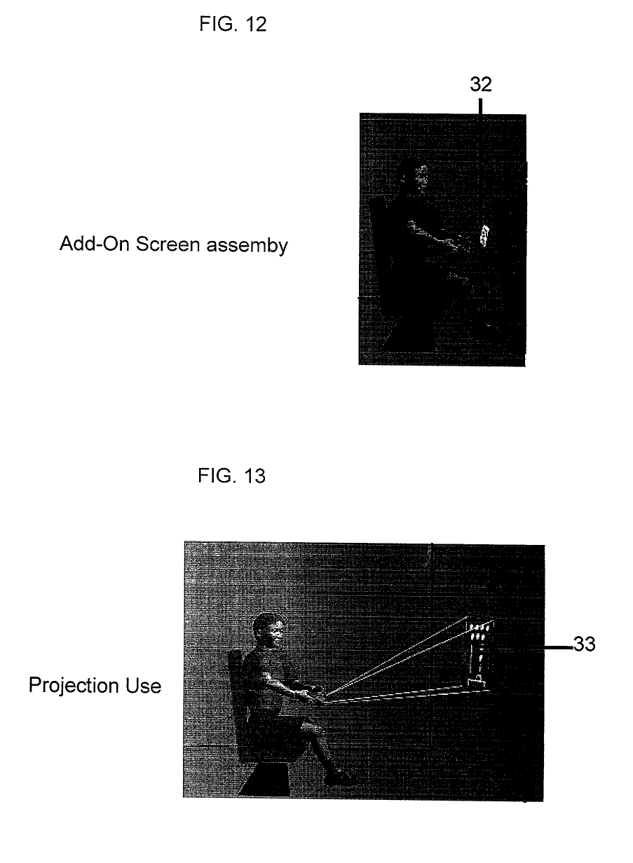

FIG. 12 shows an illustration of a child using the invention to project an image 33 onto an attached screen assembly 32

FIG. 13 shows an illustration of a child using the invention to project an image 33 onto a wall.

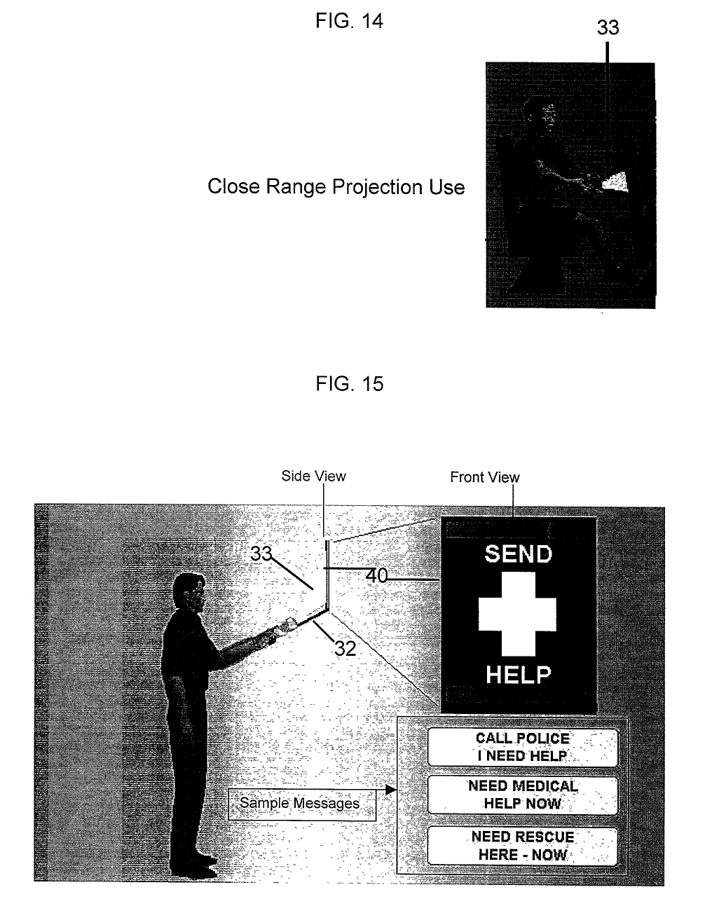

FIG. 14 shows an illustration of a child using the invention to project an image 33 onto a seat back in front of his position.

FIG. 15 shows an illustration of a man using the invention to project an image 33 onto an attached screen assembly 32 for an emergency use.

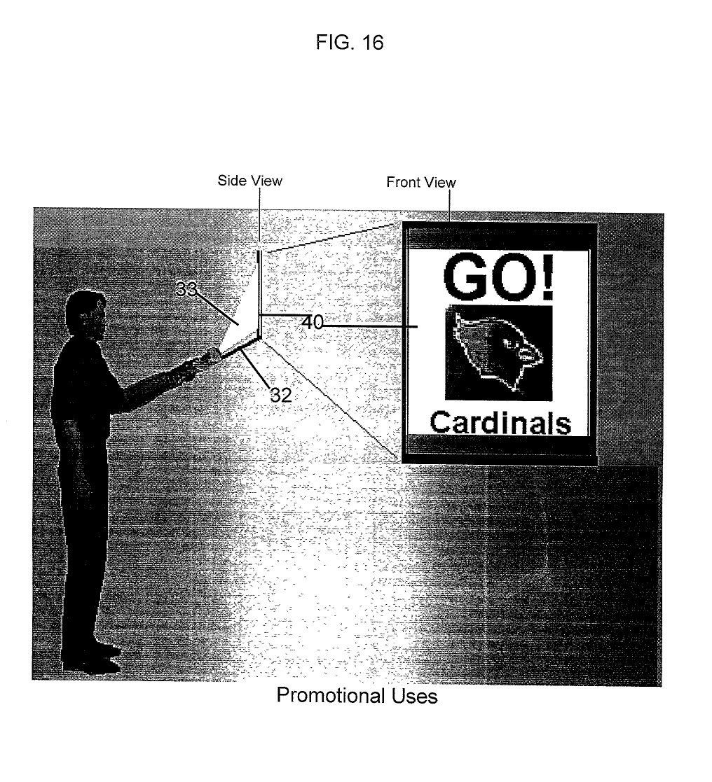

FIG. 16 shows an illustration of a man using the invention to project an image 33 onto an attached screen assembly 32 for a promotional use

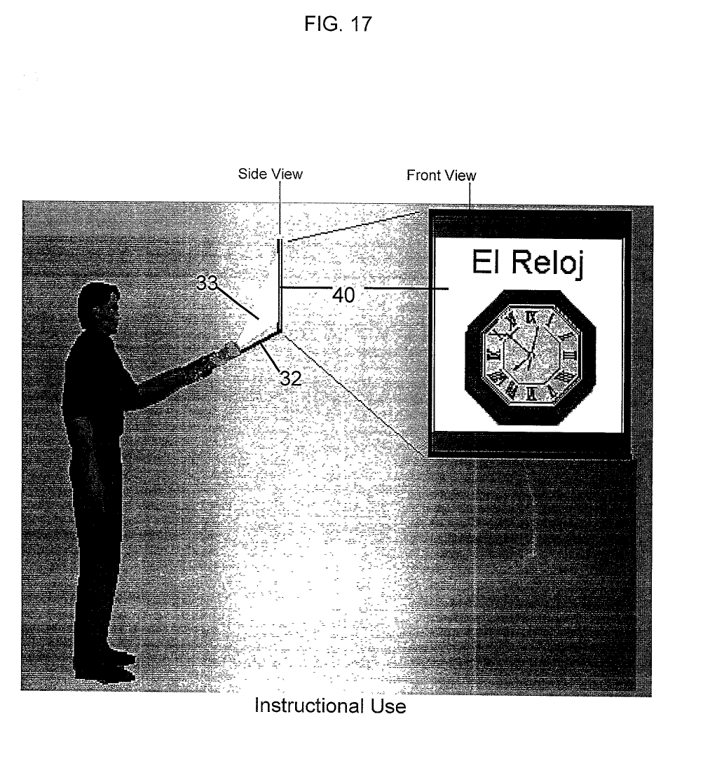

FIG. 17 shows an illustration of a man using the invention to project an image 33 onto an attached screen assembly 32 for an instructional use,

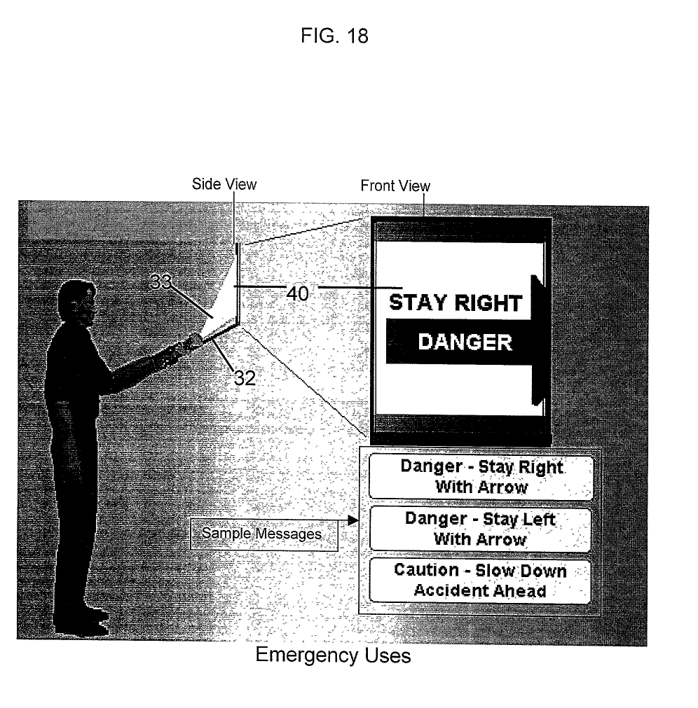

FIG. 18. shows an illustration of a man using the invention to project an image 33 onto an attached screen assembly 32 for a traffic situation use.

FIG. 33 shows the screen assembly 32 and an external device adaptor 36 and an external device 37 in their mounted positions on the invention.

FIG. 34 shows the screen assembly 32 and an external device adaptor 36 and an external device 37 in an exploded view ready to be mounted to the invention.

FIG. 35 shows the interior components of front assembly 14 with details of the focus system describe in FIGS. 26a and 26b

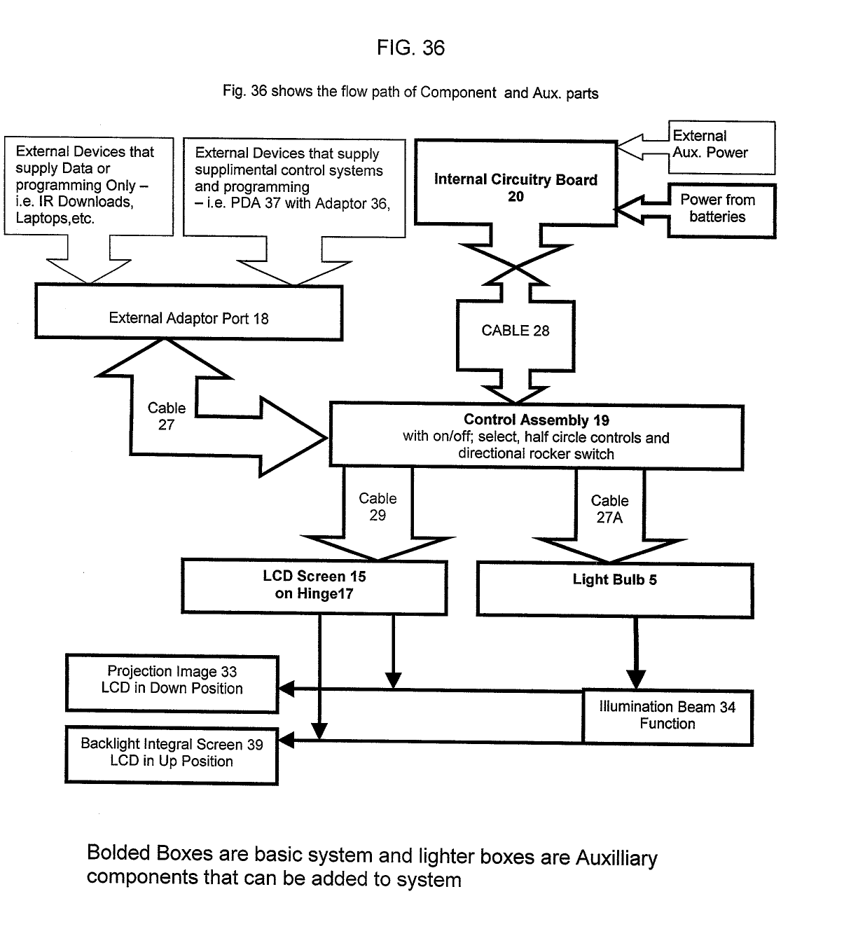

FIG. 36 shows the component flow path that connects all the electronic components that make up electronics assembly 26 and the three modes (Illumination, Backlight Image and Projected Image) of operation of the invention.

### Operation of the Preferred Embodiment of the Invention

### Three Basic Functions of the Invention

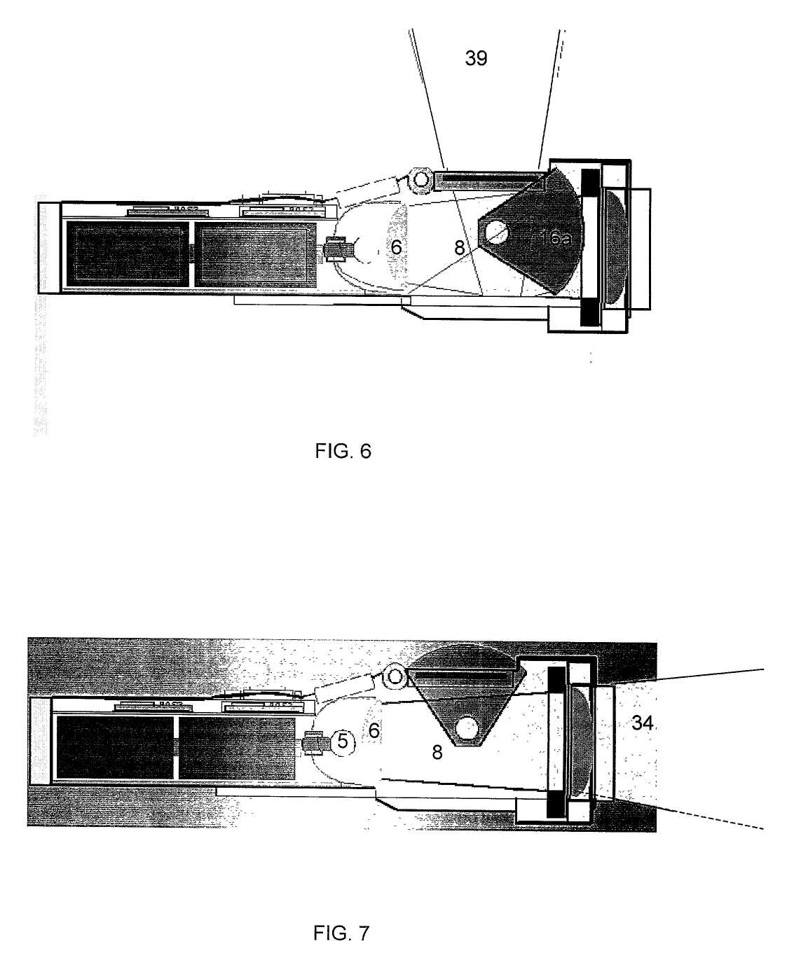

The operation of the preferred embodiment of the invention can be broken down into three basic functions. They are [a] using the invention as a flashlight or as an illumination function (as shown in FIG. 7); or [b] using the invention in a handheld data display function utilizing an integral backlit screen as the data's direct display device (as shown in FIG. 6). In this function the invention can be used in multiple ways depending upon the type of processing hardware on the internal circuitry 20 and type of programming placed in the invention's internal circuitry 20. This includes use as a game, presentation system or other function determined by on-board hardware and software and add-on devices; or [c] as a projection system using the integral image source (i.e. the LCD screen) to create the images which are then projected by the illumination source onto a surface (as shown in FIG. 5) or attached screen (as shown in FIG. 1a and 11b).

Each of the three functionalities utilizes various components of the invention in different physical arrangements within the housing of the invention. The two data display functionalities (internal and projection) can be controlled by the control assembly 19 or can also interface through the external systems adaptor 18 with the external device adaptor 36 and an external device 37 so that alternate controls and alternate data (content and programming) can be provided to the invention. Each of three basic functionalities shown in FIGS. 5, 6 and 7 is described separately below. External device adaptor functionality is described later in this embodiment.

### Controls and Electronics

FIG. 20 shows details of the six basic on-board electronic controls of the invention. Although all controls can be modified with on-screen interpolation of controls functions, the basic controls shown can be standard for the basic functionality of the invention. The select button 19a provides the user with a single dominant control that selects on-screen options. The options presented on-screen can vary based on the available programming that is integral to the invention but the basic selections can include, but are not limited to, on-screen functions (i.e. select from games, data, multimedia) and device options (i.e. illumination only with no LCD activation, backlight intensity/illumination beam intensity control, on-screen battery life indicator, etc.). The two semi-circular buttons 19b and 19d surround a central round multi-directional mouse 19c. The semi-circular buttons 19b and 19d can provide left and right or yes-no functions while the central round multi-directional mouse 19c can provide screen navigation of a cursor like a mouse function. The On button 19f and the Off button 19e do what their names imply by turning on and turning off the main light bulb 5 and activating the power to the integral LCD screen 15.

### Positioning Control Surfaces and Moving Internal Components

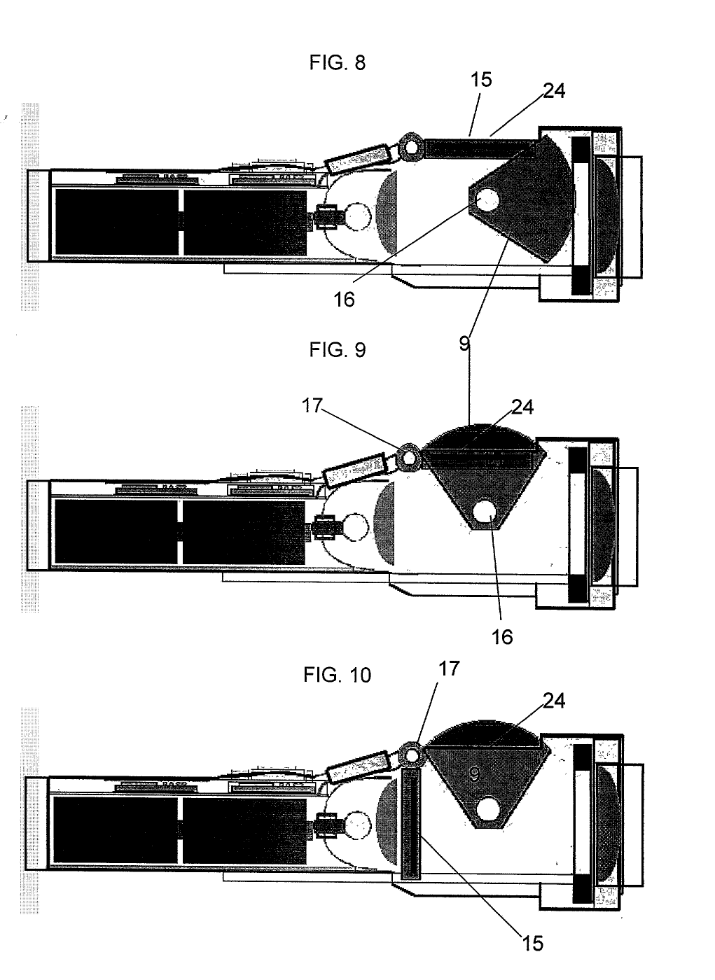

FIG. 8, FIG. 9 and FIG. 10 show the internal configuration of the three functional positions of the invention's two lever operated hinged components (the hinged LCD screen in its carrier 17, and the light hood hinge 16. FIGS. 21a-21c shows the exterior relationship of the lever controls that change the positions of the hinged components. As shown in the FIGS. 21a, 21b and 21c a pair of exterior levers (LCD control lever 30 and light hood adjustment lever 31) on each side of the invention control the changing of the different positions of the light hood 9 and the LCD screen in carrier 15. LCD lever 30 is an extension of LCD hinge 17 that protrudes perpendicular to the hinge at each end, thus creating a rotational LCD control lever on opposite sides of body 1. Light hood control lever 31 is an extension of light hood hinge 16 and protrudes outside the body 1 perpendicular to the hinge shaft on each side of light hood 9, thus creating a light hood control lever on opposite sides of body 1. Both light hood control lever 31 and LCD control lever 30 can pivot 90 degrees of rotation on their respective hinges.

FIG. 21a shows an exterior view of the LCD control lever 30 in position 17a and the light hood control lever 31 in position 16a. As shown in FIG. 8 (with LCD lever 30 in position 17a not visible) the LCD screen in its carrier 15 is in body opening 24 in a position not in line with and perpendicular to the rear lens 6 and light bulb 5. As shown in FIG. 8 (with light hood lever 31 in position 16a not shown) the main body of light hood 9 is in a position in line with and parallel to rear lens 6 and light bulb 5. In views FIG. 6, FIG. 8 and FIG. 21a the invention is in the LCD backlight mode. In this mode the illumination from bulb 5 is blocked by light hood 9 from escaping the invention through the front assembly 14. The light source can reflect off of the interior side of light hood 9 inside the motion cavity 8 so that its direction is altered to emit through the body opening 24 that is blocked by LCD screen in its carrier 15. The light passes through the LCD screen creating a backlight effect on the screen. Controls 19 can be used to select the intensity of the light emitted from bulb 5 and create the optimal backlight viewing of the LCD screen for the user.

FIG. 21b shows an exterior view of the LCD control lever 30 in position 17b and the light hood control lever 31 in position 16b. As shown in FIG. 10 (with LCD lever 30 in position 17b not visible) the LCD screen in its carrier 15 is rotated 90 degrees inward (from its position in FIG. 21a) through the motion cavity 8 and resting perpendicular to the body opening 24 in a position in line with and parallel to the rear lens 6 and light bulb 5. As shown in FIG. 10 (with light hood lever 31 in position 16b not shown) the light hood 9 is in a position to cover the body opening 24 because it is perpendicular to and out of the direct line with rear lens 6 and light bulb 5. In both views FIG. 10 and FIG. 21b the invention is in the Projection mode (also shown in FIG. 5) where the LCD in its carrier 15 is in front of light bulb 5 and rear lens 6 is capable of creating a projection beam of the image on the LCD screen 15. In this configuration there is no light hood 9 interference with the projection beam emitting directly from the front assembly 14.

FIG. 21c shows an exterior view of the LCD control lever 30 in position 17a and the light hood control lever 31 in position 16b. As shown in FIG. 9 (with LCD lever 30 in position 17b not visible) the LCD screen in its carrier 15 is rotated to be parallel to body opening 24 in a position perpendicular to the rear lens 6 and light bulb 5. As shown in FIG. 9 (with light hood lever 31 in position 16b not shown) the light hood 9 is in a position to cover body-opening 24 as well as cover the LCD screen in its carrier 15. This is because light hood 9 is perpendicular to and out of direct line with rear lens 6 and light bulb 5. In both views FIG. 9 and FIG. 21c the invention is in the Illumination mode (also shown in FIG. 7) where the LCD in its carrier 15 is out of the way of light bulb 5 and rear lens 6 and when activated by controls 19 is capable of creating an illumination beam 34 that has no light hood 9 interference with the illumination beam 34 emitting directly from the front assembly 14.

The above referenced positions for the control levers 30 and 31 form the operational basis for the three basic modes of functionality of the invention. Control assembly 19 and internal circuitry board 20 electronics within the invention permit the control and alteration of the content (either directly viewed or via projection).

A user of the invention can change from any of the three modes to either of the other two modes by moving one or both of the external levers 30 and 31. To change from viewing the internal LCD screen via backlight to projecting the image up on a surface requires shifting two levers 90 degrees.

### Keystone Projection Effect Adjustment

FIG. 25a and 25b shows a view of the front assembly 14 in two positions. One of the purposes of the components in front assembly 14 is to adjust its projection angle to compensate for what is known as the keystone image distortion effect. This distortion effect happens when a screen and projection device are not perpendicular to each other. FIG. 25a and 25b show an angular beam displacement via a manual manipulation of the exterior light aperture tube 13.

FIG. 25a shows the downward orientation of the front carrier tube 11 via the attached exterior light aperture tube 13 that contains the front lens 12. The front lens adjustment rail 10 allows the downward rotation and linear motion of the front carrier tube 11 on the adjustment pins 25 within the front assembly 14. The adjustment pins 25 on either side of the front carrier tube 11 ride in adjustment rail 10 via a friction fit that allows the pins to slide forward and backward in the adjustment rail 10. The adjustment pins 25 also rotate in a friction fit within the adjustment rail 10. This rotational motion allows the front carrier tube 11 to pivot the entire front carrier tube 11 as shown in FIGS. 25a and 25b.

FIG. 25b shows the upward orientation of the front carrier tube 11 via the attached exterior light aperture tube 13 that contains the front lens 12. The front lens adjustment rail 10 allows the upward rotation and linear motion of the front carrier tube 11 on the adjustment pins 25 within the front assembly 14.

### Lens Focus Adjustment

FIG. 26a and 26b shows a view of the front assembly 14 in two positions. One of the purposes of the components in front assembly 14 is to focus the projected image 33. FIG. 26a and 26b show a front lens adjustment within the exterior light aperture tube 13 via a manual rotational manipulation of the exterior light aperture tube 13.

As shown in FIG. 35 (with motion shown in FIG. 26a and FIG. 26b) the exterior light aperture tube 13 is mounted via a mated molded configuration to the front carrier tube 11. These mating parts are via a groove 42 in the forward face of front carrier tube 11 that accepts retainer protrusions 43 in the rear surface of the exterior light aperture tube 13. This allows the exterior light aperture tube 13 to freely rotate around the common center linear axis of the stationary front carrier tube 11. Front lens 12 rides in lens holder 38 that has threads 35 on its exterior circumference. Front carrier tube 11 has one or more lens focus rails 41 that protrude down the interior length of the interior open space of the exterior light aperture tube 13. The front lens 12 in lens holder 38 has holes 44 that allow lens focus rails 41 to pass through the lens holder 38. The lens holder 38 has the exterior circumference mating threads 35 to the threads 13a that are integral to the interior circumference of exterior light aperture tube 13. When exterior light aperture tube 13 is rotated it causes front lens threads 35 to cause forward lens 12 in lens holder 38 to move linearly via threads 35 on stationary lens focus rails 41. Depending upon the direction of the rotation of exterior light aperture tube 13 the forward lens 12 will move forward or back in the front assembly 14.

FIG. 26a shows the forward orientation of the front lens 12 within the exterior light aperture tube 13. The front lens 12 moves on front lens threads 35 that allow the forward linear motion of the front lens 12 within the exterior light aperture tube 13 of the front assembly 14.

FIG. 26b shows the rearward orientation of the front lens 12 within the exterior light aperture tube 13. The front lens 12 moves on front lens threads 35 that allow the rearward linear motion of the front lens 12 within the exterior light aperture tube 13 of the front assembly 14.

### Add-On Screen Functionality

FIG. 27 shows an attachable screen assembly 32 in position to be mounted into the screen postholes 24 in the exterior body 1 of the invention.

FIG. 28 shows the screen assembly 32 in its fully deployed configuration. The flexible translucent screen 23 and adjustable screen hinge 22 allow the screen posts 21 and translucent screen 23 to be folded and reconfigured into a smaller shape for storage of screen assembly 32.

FIG. 27 and FIG. 28 show that a user can insert an add-on screen assembly 32. FIGS. 11 and 1 la show the add-on screen assembly 32 attached for viewing the projected image 33. Views in 3D FIGS. 29, 30, 31 and 32 show the add-on screen assembly 32 from different perspectives that illustrate its functionality. The add-on screen assembly 32 has a screen surface 23 attached to insertable screen posts 21.The screen assembly 32 has prongs or rods on the end of the insertable screen posts 21 that mate with holes 24 on the front assembly 14. The screen assembly 32 has a hinge 22 or other adjustable joint assembly that allows the screen to be placed in the optimal position for viewing the projected image 33. The screen surface 23 is made of a flexible or rigid translucent material so the projected image 33 can be seen on both sides of the screen surface 23. The control assembly 19 allows the user to select the orientation of the screen content of the projected image 33 so that it is correct for the side of the screen surface 23 that is being viewed. The controls 19 utilize the internal processing circuitry 20 to adjust the signals sent to the LCD in its carrier 15 that creates the projected image 33.

FIG.'s 29, 30, 31 and 32 show the attached screen assembly 32 in various views of its attachment to the invention. When attached as shown in these views the screen assembly 32 can receive images projected from the invention. This projected image 33 can be corrected for focus and keystone orientation utilizing the components of front assembly 14 as described above. This adjustment capability allows the invention to provide a clear, proportional and focused image regardless of the type of screen used, or lack of attached screen when used on a wall or other surface.

### External Devices

FIG. 34 shows the screen assembly 32 and an external device adaptor 36 and an external device 37 in an exploded view ready to be mounted to the invention. External device adaptor 36 mounts onto integral connectors of the external systems adaptor 18 of the invention. This connection is made via physical interlocking of mating structures on the bottom of the external device adaptor 36 and the top of the external systems adaptor 18. These physical mating structures (not shown) can be tracks, pin inserts or any other type of mating system that can tie both the physical structure and the electronics together between the external device adaptor 36 and the top of the external systems adaptor 18. The mating of the physical structure of the external device adaptor 36 with the external device 37 depends upon the specific device to be attached. Each external device adaptor 36 will have a specific mating system that is designed to mate with the existing connection port on a specific external device 37 (i.e. a Palm PDA is shown in FIG. 33 and 34 with a corresponding type external device adaptor 36).

FIG. 33 shows the screen assembly 32 and an external device adaptor 36 and an external device 37 in their mounted positions on the invention. In this composite structure of the invention with mounted add-on screen assembly 32 and external device 37, the invention is capable of transferring data from the external device 37 through the external device adaptor 36 into the electronics of the internal circuitry board and projecting it on the add-on screen assembly 32.

### Conclusions, Ramifications and Scope of the Invention

By reviewing the above embodiment the reader can see that the combination of features in the invention provides a highly advantageous hand held illumination and presentation system that allows for safety, gaming, educational, promotional and business functions. The system's physical operation is simple to use and easy to understand. With the addition of an add-on screen, use of surfaces as screens, and supplemental attached external devices, the invention can perform many different functions that can benefit from the projection of multimedia content.

While the above description contain many specificities, these should not be construed as limitations on the scope of the invention, but rather as an exemplification of one preferred embodiment thereof. Many other variations are possible and can be envisioned by anyone skilled in the art without leaving the scope of the intent of the invention. Accordingly, the scope of the invention should not be determined only by the embodiment illustrated, but by the appended claims and their legal equivalents.

What is claimed is:

1. A handheld machine for projecting an illumination beam or electronically generated visual displays comprising:
a. A means of displaying an electronically generated image on a display integral to the machine,
b. A means of projection of said electronic image onto a display surface that is either attached or un-attached to the machine.

2. The handheld machine of claim 1 further includes a combined illumination means that can be used as a flashlight and as a projection device that utilize the same light source for these different uses.

3. The handheld machine of claim 1 further includes an illumination and projection device that utilizes a data information device comprising a means to control the selection of the device's functionality from illumination device to data information device.

4. The handheld machine of claim 1 further including an external data entry means that is in connection with the output seen on the integral display or projected image comprising:
a. An external system adaptor capable of accepting modules which allow the connection of various data sources including interfacing with direct cable linkage to computer data systems, infrared data transmission, radio frequency data transmission and by any methodology used to transfer data between electronic devices,
b. An external system adaptor capable of accepting modules that physically interface with other electronic data devices such as a personal digital assistant (PDA), laptop computer, cell phone, etc. so that the functionality of the external device can be displayed by the internal or projection display options of the machine,
c. An external system adaptor capable of accepting modules that physically interface with onboard or connectable input controls to play games, manipulate on-screen commands and generally interface with the data producing the images generated by the machine.

5. The handheld machine of claim 1 further includes the means to manipulate and retrieve the data for controlling the display output comprising one or more computer chips and memory sources including onboard memory and/or removable modular memory.

6. The handheld machine of claim 1 further includes the means to make the illumination function operate independently from the display or projection function;

7. The handheld machine of claim 1 further includes the ability to use the illumination function as a backlight for an internal display screen.

8. The handheld machine of claim 1 further includes a focusing means comprising:
a. An adjustment system for changing the focal length between the lenses in the device to create proper focus regardless of the surface on which the image is projected,
b. An adjustment system to change the angular displacement of the projection (called the keystone effect) on surfaces that are not perpendicular to the direction of the projection beam.

9. The handheld machine of claim 1 further includes an attachable add-on screen that allows the projection of an image onto a portable screen.

10. The attachable add-on screen of claim 9 further includes a screen surface made of translucent material for the purpose of projecting the image in such a fashion that it could be viewed from either sides of the translucent screen material.

11. The handheld machine of claim 1 further includes a control system to reverse the image both in a mirror fashion and/or horizontally and/or vertically, as desired, so as to allow the transmission of the proper image format via reflection off a surface, through a translucent screen material, or direct image projection and viewing.

12. The handheld machine of claim 1 further includes a control system to allow the user to control the light function for the best backlighting under any light condition from bright daylight to total darkness;

13. The handheld machine of claim 1 further includes the capability to operate on internal battery power or to be plugged into a standard power outlet when available.

14. The handheld machine of claim 1 further includes the means to physically manipulate both the internal image display means and the light path control means by movement of integral levers that control the hinge rotation their individual locations within the body of the device.

15. The handheld machine of claim 1 further includes an electronic control system on the exterior of the device that allows the user to simply operate the basic functions of the device via a series of buttons.
